(19) United States
(12) Patent Application Publication
(10) Pub. No.: US 2001/0037234 A1
(43) Pub. Date: Nov. 1, 2001

(54) Method and apparatus for determining a voting result using a communications network

(76) Inventors: Ravi A. Parmasad, Kanata (CA); Donna M. Price, Kanata (CA); Jonathan A. Roberge, Nepean (CA); Sandra L. Felskie, Nepean (CA)

Correspondence Address: ROSS D. SNYDER & ASSOCIATES, INC., 115 WILO BASIN RD., SUITE 107, AUSTIN, TX, 78746, US

(21) Appl. No.: 09/834,834

(22) Filed: Apr. 13, 2001

Related U.S. Application Data
(60) Provisional application No. 60/206,029, filed on May 22, 2000.

(51) Int. Cl. G06F 17/60

(52) U.S. Cl. 705/12

(57) ABSTRACT

A method and apparatus for allowing voting decisions to be determined through the use of a data communications network is provided. The process begins by sending consent email messages to each of the potential voters that may vote to determine the result of the voting decision. The consent email message includes a hyperlink (URL) to a consent website, where potential voters can access the consent website to provide consent information. Once the consent information for the potential voters has been gathered, a set of eligible voters is determined from the potential voters based on those which provided consent information. The consent information can include consent to receive electronic information regarding the voting decision as well as consent to vote electronically. Based on the set of eligible voters determined, a second email message is sent to each of these eligible voters, where the second email message provides notification of a voting website to these eligible voters. When the eligible voters access the voting website, their identity is validated, and voting information is collected from those eligible voters who consented to vote electronically. Additionally, the voting website may provide the links to the electronic format information corresponding to the voting issue. When an eligible voter casts his/her vote, the voting information provided in the vote is compiled to determine the final voting decision. Compilation may include storing the voting information in a database, and may also include generating and sending transfer agent email messages that provide the voting information to a transfer agent that is responsible for tallying all of the votes that are cast.

### FIELD OF THE INVENTION

The invention relates generally to communication systems and more particularly to a method and apparatus for determining a voting result using a communication system.

### BACKGROUND OF THE INVENTION

Many corporate decisions require a vote by shareholders and other stakeholders in a corporation, and in some cases the employees of the corporation that hold stock options are also eligible to vote. One example is a vote that is taken to determine whether a merger between one corporation and another corporation should take place. In many cases, the eligible voters submit a proxy vote that enables the board of directors or some other proxy holder to cast their ballots at the actual corporate meeting at which the decision is made.

In order to allow such voting to take place, a great deal of information must be provided to the shareholders or option holders or other classes of voters prior to the vote gathering process. For example, if a potential merger is being decided upon, the relevant information regarding the merger must be distributed to the shareholders and option holders to enable them to make an informed decision. The content and dissemination of such information is typically prescribed by corporate and securities legislation such that the voters in the decision are ensured of timely access and complete disclosure of the information they require to make an informed decision. When corporations are proposing a merger, or fundamental issues are being voted upon, the volume of information that must be disseminated to the voters can be extensive. Several hundred pages of printed material are often required to be distributed through the mail in order to allow such voting to take place. The printing and dissemination of such information is very costly. Furthermore, given the extensive volume of this printed matter, it is not necessarily as easy for a reader to reference and cross-reference as would be desirable.

Additional associated costs in the voting process arise when the voters mail their paper proxy form into a collection center, where the paper votes must be manually tallied. This is both time consuming and expensive. Furthermore, such manual interaction with the votes can be error prone, and, as such, the voting result determined may not be accurate.

Security is another issue of concern in such voting processes. When proxy forms or ballots are distributed through the mail or by other means of delivery, there is a risk that individuals other than the actual eligible voters may return the proxy form or ballot with a vote that does not reflect the wishes of the actual eligible voter. Although the voter is typically required to sign the proxy form or ballot prior to returning it for tallying, records that include authentication signatures for the voters are rarely maintained, and therefore the integrity of the voting process may be comprised.

An additional burden is placed upon voters due to the fact that potential voters in the decision making process must fill out their proxy form or ballot and return the paper vote by means of mail or delivery service or facsimile within a prescribed timeframe. Consequently, some voters may inadvertently or otherwise not vote. As such, the voting process may not capture as high a voter participation rate as would be desired.

Therefore, a need exists for a method and apparatus that allows for voting decisions to be determined in a manner that reduces costs, provides an accessible means by which voters may reference voting related materials, eliminates errors that may arise as a result of manual interaction, increases voter participation and which is secure to the extent that the wishes of the actual eligible voters are reflected in the voting result.

### BRIEF DESCRIPTION OF THE DRAWING

FIG. 1 includes an illustration of a flow diagram of a method for determining a voting result for a voting issue in accordance with a particular embodiment of the present invention;

FIG. 2 includes an illustration of a block diagram of a voting system in accordance with a particular embodiment of the present invention;

FIG. 3 includes an illustration of a block diagram of an alternate voting system in accordance with another particular embodiment of the present invention;

FIG. 4 includes an illustration of a flow diagram of an alternate method for determining a voting result for a voting issue in accordance with a particular embodiment of the invention;

FIGS. 5 and 6 include illustrations of example electronic mail (email) messages that may be sent based on the method illustrated in FIG. 4.

### DETAILED DESCRIPTION

Generally, the present invention provides a method and apparatus for allowing voting decisions to be determined through the use of a data communications network. The process begins by sending consent email messages to each of the potential voters that may vote to determine the result of the voting decision. The consent email message includes a hyperlink (URL) to a consent website, where potential voters can access the consent website to provide consent information. Once the consent information for the potential voters has been gathered, a set of eligible voters is determined from the potential voters based on those which provided consent information. The consent information can include consent to receive electronic information regarding the voting decision as well as consent to vote electronically. Based on the set of eligible voters determined, a second email message is sent to each of these eligible voters, where the second email message provides notification of a voting website to these eligible voters. When the eligible voters access the voting website, their identity is validated, and voting information is collected from those eligible voters who consented to vote electronically. Additionally, the voting website may provide the links to the electronic format information corresponding to the voting issue. When an eligible voter casts his/her vote, the voting information provided in the vote is compiled to determine the final voting decision. Compilation may include storing the voting information in a database, and may also include generating and sending a transfer agent or other agent email messages that provide the voting information to a transfer agent or other agent that is responsible for registering and tallying all of the votes that are cast.

By enabling information related to the vote to be distributed electronically, significant savings can be achieved by avoiding the need to mail a large quantity of paper materials to each of the potential voters. Furthermore, electronic copies of the information may be more desirable as voters can more easily reference and cross-reference the voting related documentation. By enabling a voter to cast their vote electronically, many of the burdens experienced in a traditional voting process are reduced or eliminated, thus increasing the likelihood of increased voter participation. Furthermore, the security associated with such electronic, or online voting is greater than that associated with traditional voting methods that utilize the mail or other traditional delivery methods. Receiving and compiling the votes cast electronically can also be performed automatically thereby reducing the costs associated with manually effected operations. Therefore, a more secure voting operation is achieved which is more likely to result in a determination based on the actual wishes of the voters, and the costs associated with such a determination are reduced, which is in the best interest of all parties involved.

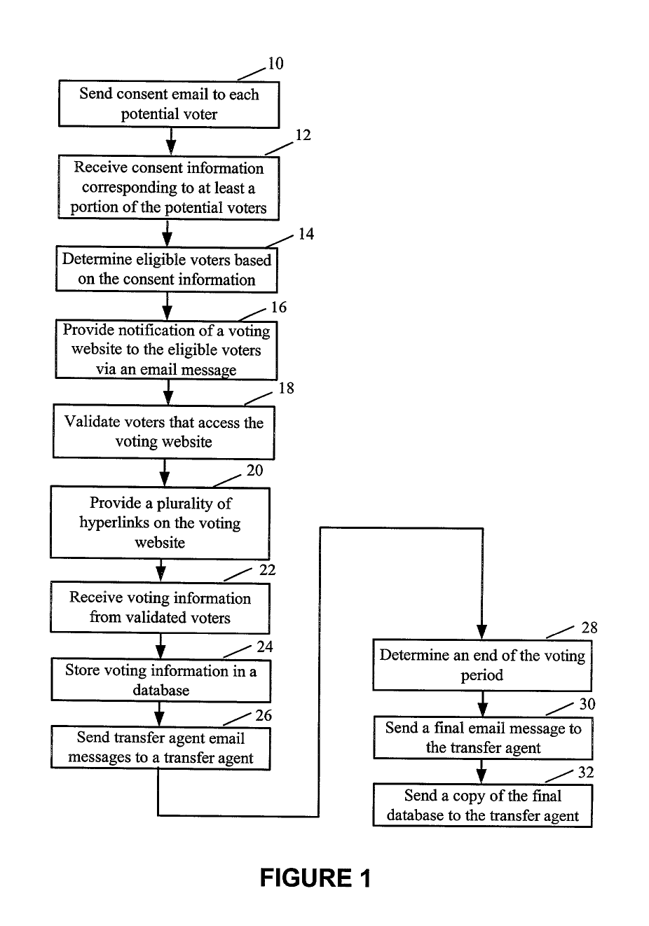

The invention can be better understood with reference to FIGS. 1-6. FIG. 1 illustrates a flow diagram of a method for determining a voting result for a voting issue. The voting issue may be a voting operation that enables potential voters to cast proxy votes electronically in connection with security holder meetings. In such an embodiment, the security holders may include both security holders that work for the corporation and those that are non-employee security holders. In some cases, the ability to cast a vote electronically and receive voting related information electronically may be limited to those employee shareholders or other voters that have access to the electronic means necessary to cast such votes electronically and receive voting related information electronically.

In a particular embodiment, the potential electronic voters may be determined based on a corporate directory that stores the email addresses for the employees based on their names and/or some other unique identifier, such as employee identification (ID) numbers. Those employees that do not have an email address are assumed to not have the electronic means necessary to cast their votes electronically, and therefore would not be included in the employee database referenced to disseminate the consent and voting email messages. Note that not all employees may possess stock in the corporation or stock options in the corporation, and as such an additional stock options database may be referenced to further sort the list of employees to which the consent and voting email messages are distributed. On a record date associated with the voting operation, the stock options database can be referenced to determine the number of votes (based on number of shares or number of options) that each employee has. This information can be combined with that stored in the corporate directory to generate a voting database that includes the employee name, their email address, and a number of votes associated with each employee.

The method of FIG. 1 begins at step 10 where a consent email message is sent to each potential voter as determined by the voting database. Thus, each employee that has electronic access and at least one vote is sent a consent email message. The consent email message includes a hyperlink, or URL, to a consent website. Upon receiving the email message, each voter may utilize the hyperlink to access the consent website. Validation as to the identity of the user can take place on the consent website such that the security, confidentiality and integrity of the voting process is preserved.

Alternatively, consent notification may be provided by a medium other than a consent email message. For example, a consent notification in the form of a hyperlink, or URL, to a consent website may be provided at the consent website or another website. As another example, a consent notification may be provided in printed materials distributed to potential voters. The consent notification serves to notify the potential voters of the consent website.

Validation of a voter can include requiring the voter to enter their user identity and a corresponding password, where the password is compared with a stored password corresponding to the user identity. The stored password may be stored within the corporate directory, or in some other secure database. The comparison result produced through the comparison of the password with the stored password determines whether or not the voter is validated. The user identity and the password may be validated using a secured data communication protocol, where a number of appropriate secure data communication protocols are commonly known in the art.

Validation of the identity of a voter may also be accomplished by detecting an electronic certificate stored on a host device associated with the voter. Thus, when the voter accesses the consent website using a particular host device, such as a desktop or laptop computer, the desktop or laptop computer may include an electronic certificate that can be used to validate the identity of the voter. Before such an electronic certificate is enabled for use in validation, additional steps may be required on the part of the voter to confirm the voter's identity such that any user of the host device cannot claim the identity of the voter via the electronic certificate. Such additional steps may include password verification, fingerprint identification, or other identity validation techniques.

The electronic certificate stored on the host device can be compared with a validation certificate stored in a validation database to produce a comparison result. When the comparison result if favorable (i.e. the electronic certificate and the validation certificate match) the voter is validated. As is apparent to one of ordinary skill in the art, other techniques for validating the identity of voters may also be used.

The consent website presents voters with the ability to consent to at least one of voting electronically and receiving voting information electronically. The voting information may include management information circulars, or other securities-related documents involved in the vote that is taking place. Typically, these documents are quite involved, and therefore the ability to disseminate them electronically as opposed to having to deliver them in paper form by mail or other means decreases the cost and complexity of the voting process.

At step 12, consent information corresponding to at least a portion of the potential voters is received. Potential voters who do not log in to the consent website to provide/deny consent are presumed to not provide consent for either electronic voting or for receiving electronic information. As such, these non-responding voters may be dealt with using conventional techniques, such as mailing the voting related information and voting forms to the voters. A cut off date may be established such that potential voters are required to provide consent or lack thereof prior to the cutoff date. As such, consent is finalized on the cutoff date such that eligible voters are determined based on those potential voters that have provided positive consent by the cutoff date.

Those potential voters that do access the consent website can provide different types of consent. Some voters may provide consent to electronic voting alone, and, in such cases, the voting information materials are distributed to these voters using conventional means. Similarly, some voters may simply consent to receiving the information electronically, and their votes are cast using conventional means, such as by mail or facsimile. Some voters may consent to both options such that they consent to receive the information electronically as well as vote electronically.

At step 14, eligible voters are determined based on the consent information received. Assuming that voters can consent to both receiving information electronically and voting electronically, eligible voters include potential voters that consent to either or both of these options.

At step 16, notification of a voting website, which may be a website maintained on a secure internal network, is provided to the eligible voters. Such notification is preferably provided via an email message, where the email message may include a hyperlink to the voting website. This hyperlink provides the eligible voter with access to the voting website. Distribution of the email messages to each of the eligible voters may be accomplished by retrieving an email address for the eligible voter from the voting database, or from the employee directory. The email message can then be sent to the eligible voter using the email address retrieved.

Once the eligible voter receives the email message, the eligible voter can access the voting website. Once an eligible voter has accessed the voting website, the identity of the eligible voter is validated at step 18 to produce a validated voter. Validation may include validation using a password or using electronic certificates as described above.

Once a voter has been validated at step 18, the voter is provided with a plurality of hyperlinks on the voting website at step 20. The plurality of hyperlinks included on the voting website may include a hyperlink to a voting page, where the voting page is used to collect the votes from each of the validated voters. Another hyperlink may direct the validated voter to an electronic information page, where the validated voter can download or view the documentation related to the voting issue on this page. Other hyperlinks that may be included on the voting website include those to discussion groups or other forums where the voting issue may be discussed.

It should be noted that the voting form provided on the voting page is recognized as a valid means for accomplishing the granting of a proxy for voting in such decisions. The validation of the user is recognized as being generally equivalent to a person signing a form, which is apparent based on the proliferation of Internet and other electronic sites that allow for binding legal transactions and other legal issues to be resolved online. As described earlier, additional security is actually provided through the validation means utilized, as signatures for the voters are not always kept on file. This can help to improve the integrity of the voting process.

Preferably, once a validated voter has cast their vote via the voting website, the validated voter is unable to electronically revoke their vote. This can help to ensure that misuse of the system does not occur. In order to ensure that voters are still capable of revoking any electronic votes that they have cast, standard revocation techniques may still be supported. For example, votes cast electronically may be revoked by mail or other delivery methods. In order to facilitate the ability to revoke such votes by mail or other delivery methods, a hyperlink may be included on the voting website, where the hyperlink directs the voter to the forms necessary to revoke a vote. Additional information may be provided via hyperlinks that informs the voter as to how to submit such a revocation form.

At step 22, voting information is received from validated voters via the voting website. At step 24, the voting information is stored in a database. The database may be the same database as was used to send out the voting and consent email messages, where the fields included in such a database are expanded to include the number of votes for each eligible voter, whether or not that voter has voted, a time stamp associated with the time at which the voter cast his/her vote, and the result of the voter's vote (e.g. for or against).

In one embodiment, the database that stores all of the voting results may simply be used to resolve the voting decision. In other embodiments, the votes may have to be relayed to a transfer agent or other agent, where the agent is responsible for tallying all the votes cast for the voting issue. For example, the agent may be a bank or other entity that is responsible for determining the validity of the proxy. In the case where the voting by the eligible voters takes place on an internal network within a corporation, the transfer agent may lie external to the corporation and as such may have to be reached via an external network. In one embodiment, the results tallied in the database may simply be forwarded over the external network to the transfer agent via an email message. Such a bulk transfer may simplify the logistics of transferring the voting information received from the voters.

In other embodiments, each time a validated voter casts a vote, an email message that includes the voting information for that validated voter may be compiled and sent to the transfer agent via the external network. Note that if the external network is not a secure network, encryption of the voting information in the transfer agent email message may take place. Note that in some embodiments, the voting information corresponding to a number of validated voters may be compiled into a single email sent to the transfer agent. At step 26, the transfer agent email messages are sent to the transfer agent.

At step 28, the end of a predetermined voting time period is determined. The predetermined voting time period is the time period during which validated voters are able to cast their votes electronically. Any default votes resulting from validated voters failing to cast a vote may be recorded once the voting time period had ended. For example, if a voter consents to voting electronically yet does not cast an electronic vote, that voter's votes may default to votes in support of granting the proxies to the board of directors. Such a voting result is recorded in the database along with an indication that the validated voter failed to cast their vote electronically. The voting information resulting from such default votes may then be forwarded to the transfer agent either via individual emails, or via a bulk email that includes all of the default voting information. At step 30, a final email that includes the default voting information is forwarded to the transfer agent.

At step 32, in order to validate the transmission of the email messages associated with carrying the voting information to the transfer agent, relevant portions of the database may be sent to the transfer agent following the transmission of the final email that included the default voting information. The transfer agent can then use these portions of the database to perform comparisons with the results tallied based on the transfer agent email messages it has received. Any discrepancies between what is stored in the database and what the transfer agent has tallied can thus be resolved prior to a final determination of the voting result.

It should be noted because the transfer agent receives the voting information in electronic form, the transfer agent is able to compile this information more easily than would be possible if paper ballots were received for all of the voters. As such, the costs associated with the compilation are significantly reduced, which benefits all parties involved. Note that the transfer agent may maintain a running tally of the voting information received thus far such that a general perspective on the likely outcome of the voting decision may be apparent. This may be facilitated by sorting emails that include voting information that correspond to either “for” or “against” voting decisions.

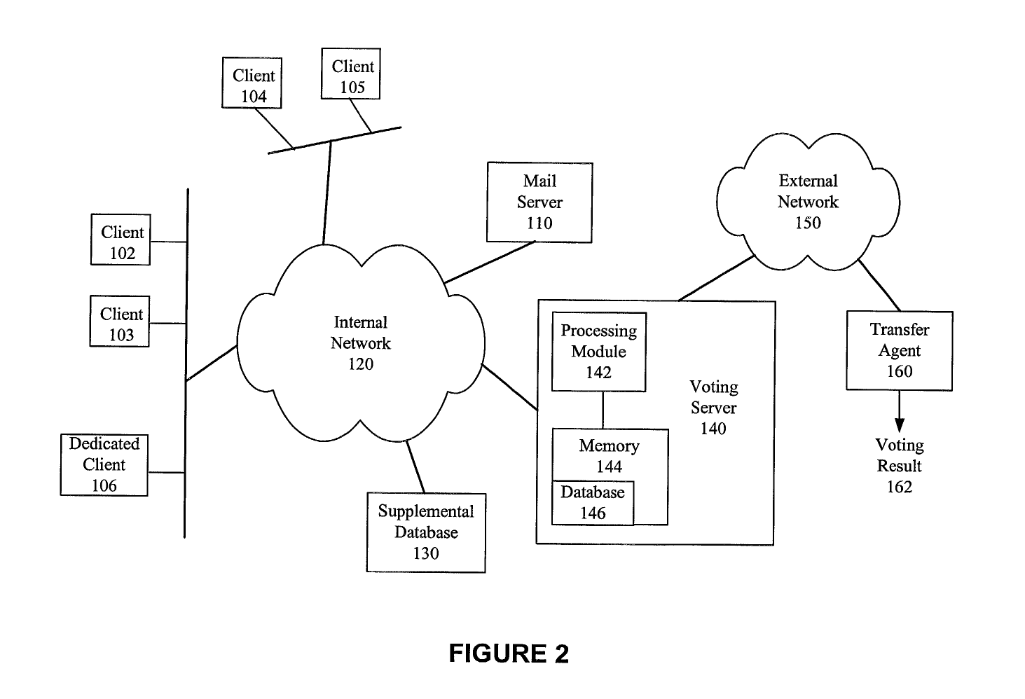

FIG. 2 illustrates a block diagram of a system in which the method of FIG. 1 may be employed to facilitate electronic voting. The system of FIG. 2 includes an internal network 120 which may be an intranet that services a corporation. Within the corporation are a number of clients 102-106, where each client provides access to the internal network 120 for at least one potential voter. A voting server 140 controls the voting process. The voting server 140 may include a processing module 142 and memory 144. The processing module 142 may include a single processing entity or a plurality of processing entities. Such a processing entity may be a microprocessor, microcontroller, digital signal processor, state machine, logic circuitry, or any device that processes information based on operational or programming instructions. The memory 144 may be a single memory device or a plurality of memory devices. Such a memory device may include read-only memory, random access memory, floppy disk memory, hard drive memory, or any type of device that stores digital information. Note that when the processing module 142 has one or more of its functions performed by a state machine or logic circuitry, the memory containing the corresponding operational instructions is embedded within the state machine or logic circuitry.

The memory 144 stores programming or operational instructions that allow the processing module 142 to perform at least a portion of the method illustrated in FIG. 1. Thus, the processing module 142 will perform a number of functions associated with determining a voting result for a voting issue. Such functions include providing notification to potential voters, receiving consent from those voters to determine eligible voters, providing eligible voters with access to the voting website, etc.

In order to allow the voting server 140 to store the relevant information required to send the email messages to the various potential and eligible voters via the internal network 120, a database 146, which may be a voting database as described above, may be included in the voting server 140, where such a database may be stored within the memory 144. In other embodiments, the database 146 may be stored either as a supplemental database 130 accessible over the internal network 120, or on a database accessible over some other type of interactive connection.

The supplemental database 130 may also represent the corporate directory for the corporation or the stockholder database for the corporation, where such databases may be referenced by the voting server 140 to determine the information that it requires to send out the consent and voting email messages described above with respect to FIG. 1.

Note that the clients 102-106 may include clients that are validated via user identification and passwords (clients 102-105) as well as dedicated client 106 which may allow for validation using electronic certificates as described above.

In order to facilitate the transference of the email messages used in the system, a mail server 110 may be coupled to the internal network 120. In addition, encryption circuitry or software may be included at various points within the system to ensure that the data communications are secure.

The voting server 140 may support the voting website that includes the hyperlinks that connect the validated voters to the voting page and the documentation page such that validated voters can retrieve desired information as well as cast their votes. Voting notification email messages provide access to the voting website managed by the voting server 140. Once the voting information has been collected from a validated voter, the voting server 140 stores the voting information in the database 146 and may compile a transfer agent email message. The voting server 140 may forward transfer agent email messages to the transfer agent 160 via an external network 150. Because the external network 150, which may be the Internet, may not be a secure network, encryption of the voting information relayed in the transfer agent email messages may be appropriate. As described earlier, the voting server 140 may compile an individual transfer agent email message for each set of voting information that it receives from a validated voter, as well as a final email message that relays any default voting information to the transfer agent 160. After all of the voting information has been transferred via email messages to the transfer agent 160, the voting server 140 may compile an additional email message that relays the compiled contents of the database 146 such that the transfer agent 160 can confirm valid receipt of all of the transfer agent email messages such that an accurate voting result 162 can be determined.

As described above, the transfer agent 160 may combine the voting information received via the transfer agent mails with other voting information corresponding to proxy forms or ballots received via conventional mail or through other means. Thus, the voting result 162 may reflect votes cast using a number of techniques.

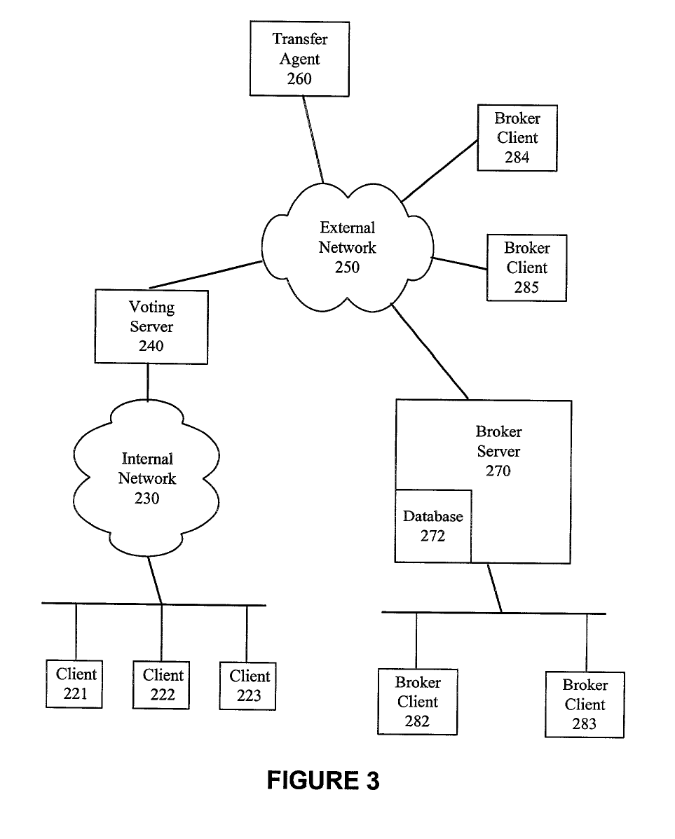

FIG. 3 illustrates a block diagram of another embodiment of the invention in which the transfer agent 260 is coupled to an external network 250, which may be the Internet. Also coupled to the external network 250 are a voting server 240 and a broker server 270.

The voting server 240 may be similar to the voting server 140 illustrated in FIG. 2. The voting server 240 is coupled to an internal network 230, which in turn is coupled to a plurality of clients 221-223. The plurality of clients 221-223 may provide access to the voting server 240 for a number of eligible voters within a corporation. The results tabulated by the voting server 240 can then be relayed via the external network 250 to the transfer agent 260 as was described above.

A broker server 270 may correspond to a brokerage house, or stock trading company that allows a number of broker clients 282-285 to trade securities either electronically or by other means. In such cases, the brokerage house typically will maintain the stock certificates for its clients such that the stock certificates would list the brokerage house as the record holder of the security. As such, when a decision such as a proxy vote is to take place, the brokerage house may be required to poll its clients in order to determine how those clients, who are anonymous with respect to the transfer agent 260, desire to vote in the voting decision.

Thus, the broker server 270 may poll the broker clients 282-285 in a manner similar to that described with respect to the voting server 140 of FIG. 2. The broker clients 282-285 may be validated and allowed to indicate their desired voting decisions, where the broker server 270 will compile these votes in a database 272. The broker server 270 may then relay this information to the transfer agent 260 via the external network 250 where encryption of the voting information may be required. The broker server 270 may relay the information using individual emails corresponding to each of the clients, or may simply compile all of the voting information in the database 272 before sending it to the transfer agent 260 in bulk.

As is illustrated, the broker server 270 may be directly coupled to some of the broker clients 282-283 via an internal network or other link, whereas other broker clients 284-285 may access the broker server 270 via the external network 250. This may be analogous to a day trading brokerage house that includes terminals directly coupled to the broker server as well as external access to the broker server 270 via the Internet.

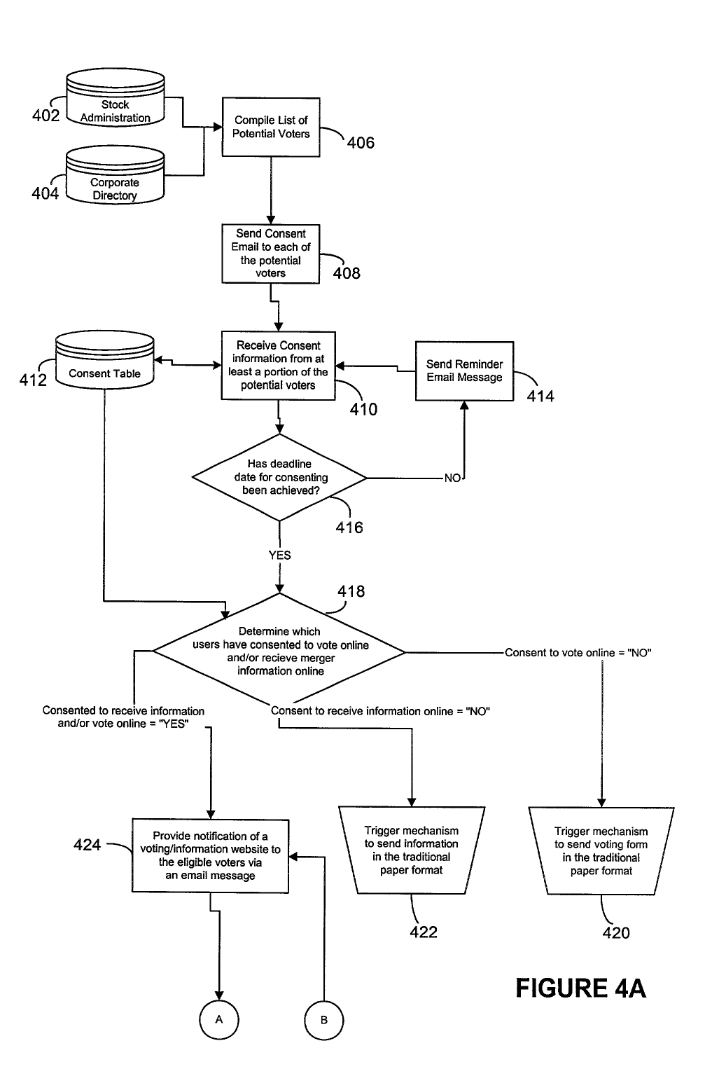

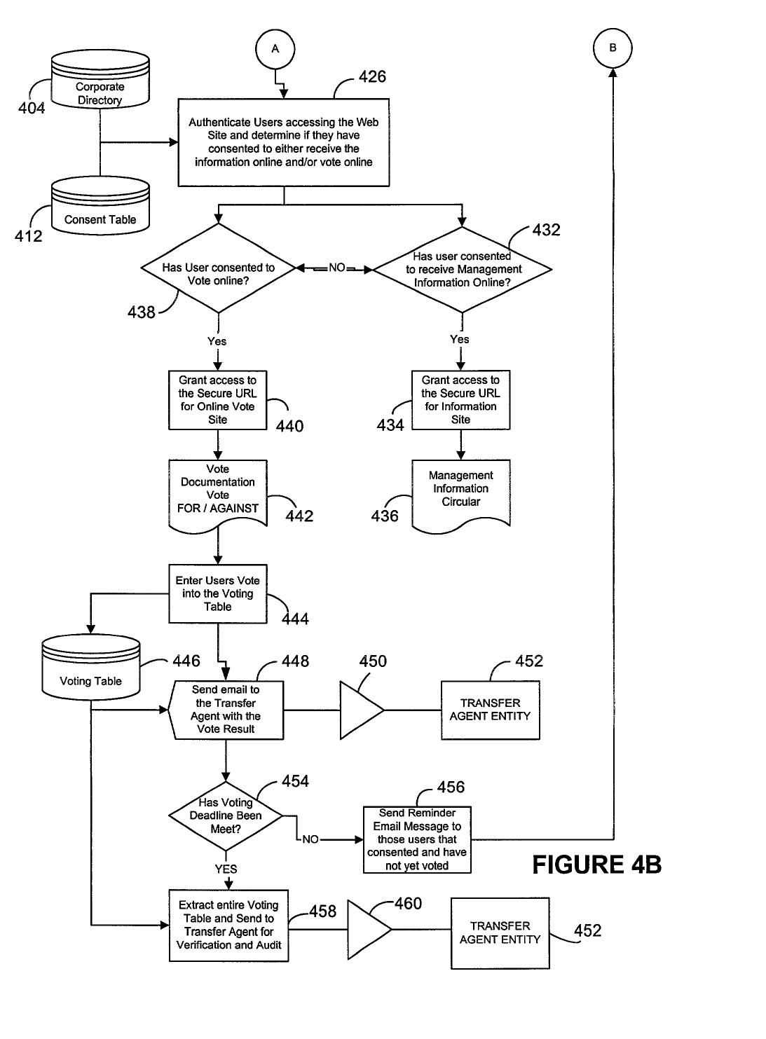

FIG. 4 illustrates a diagram that includes a number of the steps and relevant databases that are utilized in determining a voting result for a voting issue. In the example illustrated in FIG. 4, the particular voting issue to be decided is whether or not a merger between two corporations is to occur. However, as is apparent to one of ordinary skill in the art, other voting issues may be determined. The method begins at step 406 where a list of potential voters is compiled. The list of potential voters may be compiled from a corporate directory 404 in combination with a stock option or stock administration database 402. Thus, in a particular example, the list of potential voters may include those employees (as indicated in the corporate directory) that hold stock options or stock in the corporation (as indicated by the stock option or stock administration database).

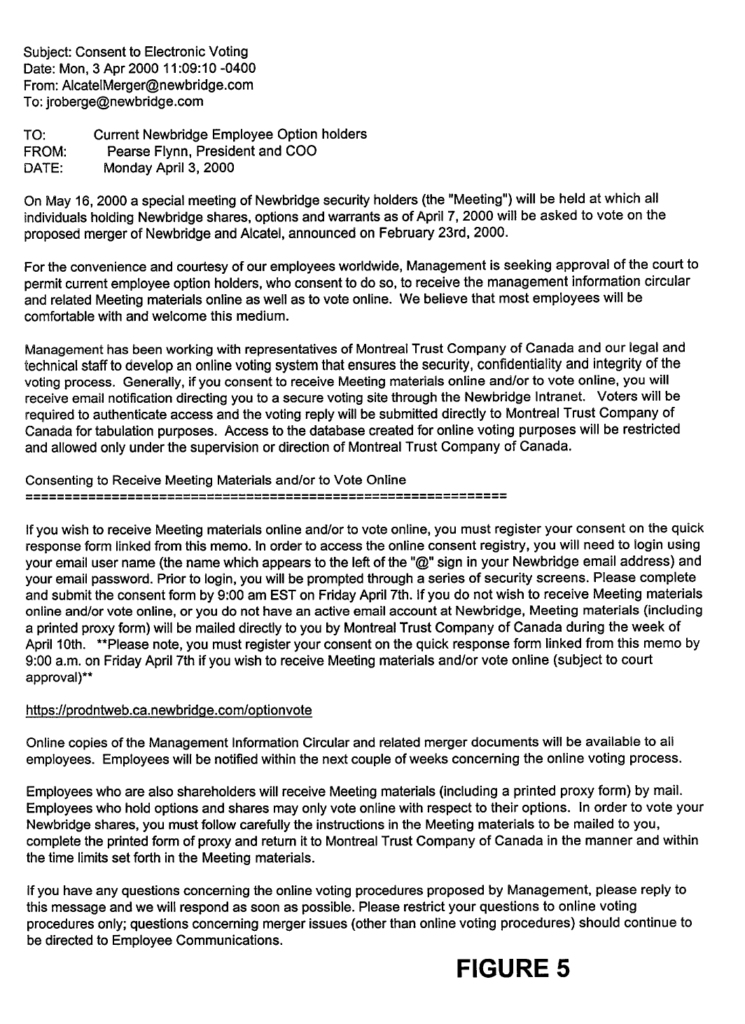

Once the list of potential voters has been compiled at step 406, a consent email is sent to each of the potential voters at step 408. An example consent email message is illustrated in FIG. 5. The corporate directory 404 may include the email address for each of the potential voters. The consent email polls each of the potential voters as to whether or not they are willing to vote online and/or receive information corresponding to the voting issue online.

Alternatively, consent notification may be provided by a medium other than a consent email message. For example, a consent notification in the form of a hyperlink, or URL, to a consent website may be provided at the consent website or another website. As another example, a consent notification may be provided in printed materials distributed to potential voters. The consent notification serves to notify the potential voters of the consent website.

At step 410, consent information is received from at least a portion of the potential voters. Thus, some of the potential voters may not reply to the consent email message sent out at step 408. Preferably, those voters that do not respond to the consent email are assumed to not consent to voting or receiving information online. The information gathered from the consent information received at step 410 is stored in a consent table 412 that can then be used to determine which voters are expected to cast their vote or receive information online. At step 416, it is determined whether or not the deadline date that has been set for receiving consent information from the potential voters has yet been reached. If not, one or more reminder email messages may be sent at step 414 in an attempt to increase the percentage of potential voters that provide their consent.

Once the deadline date for consenting has been reached no more consent information is accepted. The method then proceeds to step 418 where the users (potential voters) that have consented to vote online and/or receive merger information online can be determined based on the consent table 412. For each potential voter, it is determined whether or not the voter has consented to these potential online options. For potential voters that have not consented to vote online, the method proceeds to step 420 where a mechanism is triggered such that a conventional voting form in traditional paper format is sent to that potential voter (typically via mail). For a potential voter that has not consented to receive information online, the method proceeds to step 422 where a mechanism is triggered such that the merger information is sent to that voter in the traditional paper format. Steps 420 and 422 may include the generation of lists of voters that are to receive paper copies of documentation or voting forms, where such lists can then be provided to an appropriate mailing agent for manual processing.

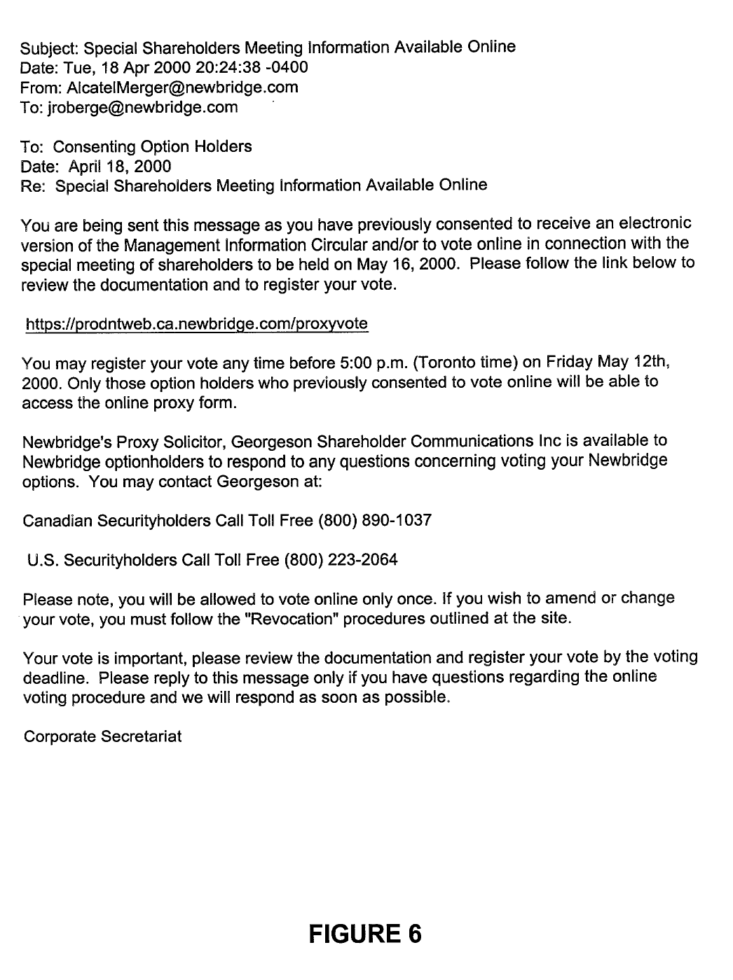

For those potential voters that have consented to receive information and/or vote online, the method proceeds to step 424. At step 424, notification of a voting/information website is provided to those eligible voters that have consented to either receiving information or voting online. Preferably, the notification of the voting/information website is provided via an email message. An example of such an email message is illustrated in FIG. 6.

Once users have received the notification as to the voting/information website, the users are able to log into that website in order to either receive the electronic information or cast their vote. At step 426, users that access the website are authenticated to determine if they have in fact consented to either receive the information online and/or vote online. Authentication may utilize the corporate directory 404 and consent table 412, where the consent table 412 indicates which voters have consented to receiving information and voting online, and the corporate directory 404 may be used to authenticate the users based on passwords or other information stored within the corporate directory 404. Note that a number of potential authentication techniques may be used, some of which have been described in additional detail above.

Once a user that has logged in has been authenticated at step 426, the method proceeds to at least one of steps 432 and 438. At step 432 it is determined whether or not the particular user has consented to receive the voting information online. If so, the method proceeds to step 434 where access to a secure URL for the information site is granted. Using this access, the user can then access information, such as a management information circular as shown in the example illustrated, at step 436. If at step 432 it is determined that the user has not consented to receive the information online, the method proceeds to step 438.

At step 438, it is determined whether or not the user has consented to voting online. Note that if step 438 is performed prior to step 432, a negative determination as to consenting to vote online at step 438 will result in the method proceeding to step 432.

If it is determined at step 438 that the user has in fact consented to voting online, the method proceeds to step 440 where access to a secure URL for online voting is granted. At this site, the user may access voting documentation and may be able to place their vote for or against the merger issue that is to be decided. Note that access to the secure URLs for both the online voting and the information retrieval may be provided simultaneously in a single web page. Thus, if the user has consented to both receipt of the information online and voting online, both URLs may be made available on the particular web page, whereas if the voter has only consented to one or the other of these options, only the appropriate URL will be presented to the user.

After a particular user has voted, the user's vote is entered into a voting table 446 at step 444. Note that in some instances, the voter may be provided with additional options as opposed to simply being able to vote for or against a particular issue. For example, the voter may be able to nominate or select a particular proxy representative other than a set of default names that are indicated on the web page for selection. Such information may also be stored within the voting table 446 for later use.

At step 448, an email message 450 is generated for a particular user's vote or for a group of votes corresponding to a number of voters. The email message 450 is then sent to the transfer agent entity 452, where the email message 450 indicates the particular voting result or results. The transfer agent entity 452 then adds the vote or votes to running tallies such that when all votes have been received, the transfer agent entity 452 will be able to make a determination as to the voting result.

At step 454 it is determined whether or not the deadline for voting has been reached. If not, at step 456 one or more reminder email messages may be sent to those voters that have consented, but have not yet voted. If the voting deadline has been reached, the method proceeds to step 458.

At step 458, the entire voting table 446 is extracted and sent to the transfer agent entity 452 in an email 460 for verification and audit. The transfer agent entity 452 can then compare the results within the voting table 446 with those that have been compiled based on the email messages sent at step 448. As such, a running tally is maintained within the voting table 446, as well as by the transfer agent entity 452 based on emails 450 received during the voting process. A comparison between the cumulative results within the voting table 446 and those compiled by the transfer agent entity 452 ensures that email messages 450 sent during the voting process were not lost in transit.

Access to voting table 446 may be limited. Use of email for communication of voting table 446 provides one example of limiting access to voting table 446. Email 460 and/or email message 450 may be encrypted and/or digitally signed to limit access to and to authenticate voting table 446 and/or individual votes. The information/voting website may be configured to limit access to voting table 446 as it is stored on the information/voting website before, during, and/or after transmission of email 460. The transfer agent entity 452 may be configured to limit access to voting table 446 and/or individual votes after they have been received at the transfer agent entity 452.

By enabling voting information to be disseminated electronically and by allowing voters to cast their votes electronically, the ease with which voting in corporate elections, and other elections, takes place can be greatly simplified. Such simplification provides benefits both in terms of reduced costs and greater voter response. Because the shareholders own the corporation, reduced costs on the part of the corporation are desirable to the shareholders, and as such, electronic dissemination of information and electronic voting are likely to be popular with the shareholders. As accessibility to the Internet and other electronic networks continues to grow, such electronic information dissemination for shareholder decisions as well as electronic voting capabilities will become even more desirable.

In the foregoing specification, the invention has been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all the claims. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A method for determining a voting result for a voting issue, comprising:
providing notification of a voting website to a plurality of eligible voters, wherein the notification is provided via an email message sent to each eligible voter of the plurality of eligible voters, wherein the notification provides the plurality of eligible voters with access to the voting website;
for each eligible voter of the plurality of eligible voters that accesses the voting website, validating identity of the eligible voter to produce a validated voter;
receiving voting information from validated voters; and
compiling the voting information from the validated voters to produce the voting result.

2. The method of claim 1, wherein the email message provided to each eligible voter includes a hyperlink to the voting website.

3. The method of claim 1, wherein providing notification further comprises, for each eligible voter:
retrieving an email address for the eligible voter from a voter database; and
generating the email message sent to the eligible voter using the email address retrieved.

4. The method of claim 1 further comprises providing a plurality of hyperlinks on the voting website, wherein a first hyperlink of the plurality of hyperlinks directs an eligible voter to a voting page and a second hyperlink of the plurality of hyperlinks directs the user to documentation related to the voting issue.

5. The method of claim 1 wherein providing the plurality of eligible voters with access to the voting website further comprises:
sending a consent email message to each potential voter of a plurality of potential voters, wherein the consent email message includes a hyperlink to a consent website;
receiving consent information corresponding to at least a portion of the plurality of potential voters based on responses provided by the at least a portion of the plurality of potential voters via the consent website; and
determining the plurality of eligible voters from the at least a portion of the plurality of potential voters based on the consent information.

6. The method of claim 5, wherein consent information includes consent to vote electronically and consent to receive documentation electronically, wherein at least one hyperlink is provided on the voting website, wherein a first hyperlink directs an eligible voter to a voting page when the eligible voter has consented to vote electronically, and a second hyperlink directs the eligible voter to documentation related to the voting issue when the eligible voter has consented to receive documentation electronically.

7. The method of claim 1, wherein validating identity of the eligible voter to produce a validated voter further comprises:
receiving a user identity from the eligible voter;
receiving a password from the eligible voter;
comparing the password with a stored password corresponding to the user identity to produce a comparison result, wherein when the comparison result is favorable, the eligible voter is validated to produce a validated voter.

8. The method of claim 7, wherein receiving the user identity and the password is performed using a secure data communication protocol.

9. The method of claim 1, wherein validating identity of the eligible voter to produce a validated voter further comprises
detecting an electronic certificate stored on a host device associated with the eligible voter; and
comparing the electronic certificate with a validation certificate stored in a validation database to produce a comparison result, wherein when the comparison result is favorable, the eligible voter is validated to produce a validated voter.

10. The method of claim 1, wherein compiling the voting information further comprises storing the voting information in a database.

11. The method of claim 10, wherein compiling the voting information further comprises generating at least one transfer agent email message, wherein the at least one transfer agent email message includes voting information corresponding to at least one eligible voter; and
sending the at least one transfer agent email message to a transfer agent, wherein the transfer agent compiles the voting information in the at least one transfer agent email message to produce the voting result.

12. The method of claim 11, wherein the voting information in the at least one transfer agent email message is encrypted prior to sending the at least one transfer agent email message to the transfer agent.

13. The method of claim 11, wherein compiling the voting information further comprises generating and sending a transfer agent email message for each set of voting information received during a predetermined voting time period; and
sending a final email message at the close of the predetermined voting time period, wherein the final email message includes default voting information corresponding to eligible voters that failed to vote using the voting website.

14. The method of claim 13, wherein compiling the voting information further comprises transferring contents of the database to the transfer agent.

15. The method of claim 13, wherein email messages to the plurality of eligible voters are delivered via an internal network, wherein website access to the eligible voters is provided via the internal network, and wherein email messages to the transfer agent are delivered via an external network.

16. The method of claim 1 wherein providing the plurality of eligible voters with access to the voting website further comprises:
providing a consent notification to a potential voter of a plurality of potential voters, wherein the consent notification notifies the potential voter of the consent website;
receiving consent information corresponding to at least a portion of the plurality of potential voters based on responses provided by the at least a portion of the plurality of potential voters via the consent website; and
determining the plurality of eligible voters from the at least a portion of the plurality of potential voters based on the consent information.

17. The method of claim 16, wherein consent information includes consent to vote electronically and consent to receive documentation electronically, wherein at least one hyperlink is provided on the voting website, wherein a first hyperlink directs an eligible voter to a voting page when the eligible voter has consented to vote electronically, and a second hyperlink directs the eligible voter to documentation related to the voting issue when the eligible voter has consented to receive documentation electronically.

18. A voting management processor, comprising:
a processing module; and
memory operably coupled to the processing module, wherein the memory stores operating instructions that, when executed by the processing module, cause the processing module to perform functions that include:
providing notification of a voting website to a plurality of eligible voters, wherein the notification is provided via an email message sent to each eligible voter of the plurality of eligible voters, wherein the notification provides the plurality of eligible voters with access to the voting website;
for each eligible voter of the plurality of eligible voters that accesses the voting website, validating identity of the eligible voter to produce a validated voter;
receiving voting information from validated voters; and
compiling the voting information from the validated voters to produce the voting result.

19. The voting management processor of claim 18, wherein the email message provided to each eligible voter includes a hyperlink to the voting website.

20. The voting management processor of claim 18, wherein providing notification further comprises, for each eligible voter:
retrieving an email address for the eligible voter from a voter database; and
generating the email message sent to the eligible voter using the email address retrieved.

21. The voting management processor of claim 20, wherein the voter database is stored in the memory.

22. The voting management processor of claim 20, wherein the voter database is accessed by the voting management processor over a network.

23. The voting management processor of claim 20, wherein the memory stores additional instructions such that the functions performed by the processing module include providing a plurality of hyperlinks on the voting website, wherein a first hyperlink of the plurality of hyperlinks directs an eligible voter to a voting page and a second hyperlink of the plurality of hyperlinks directs the user to documentation related to the voting issue.

24. The voting management processor of claim 18, wherein providing the plurality of eligible voters with access to the voting website further comprises:
sending a consent email message to each potential voter of a plurality of potential voters, wherein the consent email message includes a hyperlink to a consent website;
receiving consent information corresponding to at least a portion of the plurality of potential voters based on responses provided by the at least a portion of the plurality of potential voters via the consent website; and
determining the plurality of eligible voters from the at least a portion of the plurality of potential voters based on the consent information.

25. The voting management processor of claim 24, wherein consent information includes consent to vote electronically and consent to receive documentation electronically, wherein at least one hyperlink is provided on the voting website, wherein a first hyperlink directs an eligible voter to a voting page when the eligible voter has consented to vote electronically, and a second hyperlink directs the eligible voter to documentation related to the voting issue when the eligible voter has consented to receive documentation electronically.

26. The voting management processor of claim 18, wherein validating identity of the eligible voter to produce a validated voter further comprises:
receiving a user identity from the eligible voter;
receiving a password from the eligible voter;
comparing the password with a stored password corresponding to the user identity to produce a comparison result, wherein when the comparison result is favorable, the eligible voter is validated to produce a validated voter.

27. The voting management processor of claim 18, wherein validating identity of the eligible voter to produce a validated voter further comprises
detecting an electronic certificate stored on a host device associated with the eligible voter; and
comparing the electronic certificate with a validation certificate stored in a validation database to produce a comparison result, wherein when the comparison result is favorable, the eligible voter is validated to produce a validated voter.

28. The voting management processor of claim 18, wherein compiling the voting information further comprises storing the voting information in the memory.

29. The voting management processor of claim 28, wherein compiling the voting information further comprises generating at least one transfer agent email message, wherein the at least one transfer agent email message includes voting information corresponding to at least one eligible voter; and
sending the at least one transfer agent email message to a transfer agent, wherein the transfer agent compiles the voting information in the at least one transfer agent email message to produce the voting result.

30. The voting management processor of claim 29, wherein the voting information in the at least one transfer agent email message is encrypted prior to sending the at least one transfer agent email to the transfer agent.

31. The voting management processor of claim 29, wherein compiling the voting information further comprises generating and sending a transfer agent email message for each set of voting information received during a predetermined voting time period; and
sending a final email message at the close of the predetermined voting time period, wherein the final email message includes default voting information corresponding to eligible voters that failed to vote using the voting website.

32. The voting management processor of claim 31, wherein compiling the voting information further comprises transferring contents of the database to the transfer agent.

33. The voting management processor of claim 18, wherein providing the plurality of eligible voters with access to the voting website further comprises:
providing a consent notification to a potential voter of a plurality of potential voters, wherein the consent notification notifies the potential voter of the consent website;
receiving consent information corresponding to at least a portion of the plurality of potential voters based on responses provided by the at least a portion of the plurality of potential voters via the consent website; and
determining the plurality of eligible voters from the at least a portion of the plurality of potential voters based on the consent information.

34. The voting management processor of claim 33, wherein consent information includes consent to vote electronically and consent to receive documentation electronically, wherein at least one hyperlink is provided on the voting website, wherein a first hyperlink directs an eligible voter to a voting page when the eligible voter has consented to vote electronically, and a second hyperlink directs the eligible voter to documentation related to the voting issue when the eligible voter has consented to receive documentation electronically.

35. A voting system, comprising:
a first network;
a voting server operably coupled to the first network; and
a plurality of clients operably coupled to the first network, wherein each of the plurality of clients provides access to the voting server to a portion of a plurality of potential voters,
wherein the voting server performs functions that include:
receiving consent information from at least a portion of the plurality of potential voters;
determining a plurality of eligible voters based on the at least a portion of the plurality of potential voters from which consent information was received;
sending voting notification email messages to the plurality of eligible voters, wherein the voting notification email messages provide access to a voting website managed by the voting server;
for each eligible voter of the plurality of eligible voters that accesses the voting website, validating the eligible voter to produce a validated voter;
receiving voting information from at least a portion of the validated voters; and
compiling the voting information from the at least a portion of the validated voters to produce a voting result.

36. The voting system of claim 35 wherein the functions performed by the voting server further include:
sending consent email messages to the plurality of potential voters.

37. The voting system of claim 35 further comprises:
a second network operably coupled to at least one of the first network and the voting server; and
a transfer agent operably coupled to the second network, wherein the voting server compiles the voting information such that compiling includes:
generating at least one transfer agent email message, wherein the at least one transfer agent email message includes voting information corresponding to at least one eligible voter; and
sending the at least one transfer agent email message to the transfer agent via the second network, wherein the transfer agent compiles the voting information in the at least one transfer agent email message to produce the voting result.

38. The voting system of claim 37, wherein the first network is a secure internal network and wherein the second network is an external network, wherein the voting information included in the at least one transfer agent email message is encrypted prior to being sent to the transfer agent.

39. The voting system of claim 37 further comprises a broker server operably coupled to the second network, wherein the broker server collects broker client voting information from a plurality of broker clients, wherein the broker server forwards the broker client voting information to the transfer agent via the second network, wherein the transfer agent compiles the voting information in the at least one transfer agent email message with the broker client voting information to produce the voting result.
